(19) United States
(12) Patent Application Publication
(10) Pub. No.: US 2008/0023157 A1
(43) Pub. Date: Jan. 31, 2008

(54) Reversable direction activation mechanism for blinds

(75) Inventor: Moshe Ganzi, Kfar Neter (IL)

Correspondence Address: THE NATH LAW GROUP, 112 South West Street, Alexandria, VA, 22314, US

(73) Assignee: HOLIS METAL INDUSTRIES LTD., Afula Ilit (IL)

(21) Appl. No.: 11/878,527

(22) Filed: Jul. 25, 2007

(30) Foreign Application Priority Data
Jul. 26, 2006 (IL) 177102

(51) Int. Cl. E06B 9/307

(52) U.S. Cl. 160/176.1 R

(57) ABSTRACT

A blind and tilt mechanism therefore, adapted to be secured within a cut-out in a headrail, the tilt mechanism comprising a casing, adapted to accommodate a cog-wheel rotatable about a first axis. The casing comprising two counter-positioned tilter hook-receiving channels, each leading to the cog-wheel sized and shaped for receiving at least a portion of a rotatable tilter hook adapted to engage and rotate the cog-wheel. The tilter hook is designed for insertion into either one of the channels, thus being able to gain a left or right orientation.

### FIELD OF THE INVENTION

This invention relates to Venetian type blinds, in particular to reversible direction tilting and cord-lock mechanisms of Venetian blinds.

### BACKGROUND OF THE INVENTION

Venetian type blinds, pleated shades, roman shades and roll up blinds usually comprise lift cords for raising and lowering the window covering material, in conjunction with a cord lock mechanism, adapted to allow the user to maintain the blinds in any desired position from fully raised to fully lowered, by locking the length of the lift cord. Venetian type blinds usually also comprise a tilting mechanism adapted for tilting the blinds for regulating the amount of light passing through the window. Both mechanisms are usually located in a support rail, commonly known as a “headrail”.

Known in the art are blinds having the cord-lock mechanism on one end of the headrail and the tilt mechanism on the other end, as well as headrails having both mechanisms located at the same end. However, nearly all blinds, pleated shades etc. are fabricated in a factory and taken in finished form, already having a right or left orientation, to the place where they are to be displayed or installed. In the installation process, the headrail is mounted on a wall portion, usually above the window such that the cord lock or tilt mechanism maintain either a right or left orientation. In addition, during installation the length of the lift cord is set.

Prior to purchase of the blinds, the customer must decide on the desired left or right orientation of the cord lock and tilt mechanism, so it may be manufactured or purchased accordingly.

U.S. Pat. No. 6,148,894 to Judkins discloses a headrail for a Venetian type blind that has reversible modular controls that can be easily switched from a right side of the blind to the left side of the blind or vice versa by the installer. The headrail has an elongated body having a base, a first sidewall and a second sidewall. The first and second sidewalls are spaced apart, generally parallel and attached to the base. Each sidewall has a slot sized to receive a plug or a fitting through which the lift cords and tilt or hook for a tilt wand pass. The slots are opposite one another and of a same size. One changes the controls from one end of the headrail to the opposite end of the headrail by moving the lift cords and tilt cord or hook from one slot to the other slot.

U.S. Pat. No. 6,899,156 to James D. Tyner discloses a headrail for a Venetian type blind or pleated shades that has an insert that carries a cord lock. The insert fits into the end of the headrail and is carried by a slot or rib on the sidewalls of the headrail. A pair of pockets is provided on the insert. The pockets are positioned so that one pocket is adjacent each sidewall when the insert is attached to the end of a headrail. The pockets are sized and configured to receive a cord lock such that the cord lock can be easily removed from one pocket and placed in the other pocket by an installer. The pockets preferably are oriented so that a cord passing through the cord lock will run along a path that is not parallel to the sidewalls but is at an angle of about 10°.

### SUMMARY OF THE INVENTION

According to a first aspect of the present invention there is provided a tilt mechanism for Venetian type blinds adapted to be secured within a cut-out in a headrail, said tilt mechanism comprising a casing, adapted to accommodate a cog-wheel rotatable about a first axis, said casing comprising two counter-positioned hook-receiving channels, each leading to said cog-wheel and sized and shaped for receiving at least a portion of a rotatable tilter hook adapted to engage and rotate said cog-wheel, said tilter hook designed for insertion into either one of said channels, thus being able to gain a left or a right orientation.

Any of the following design variations may be applied to the headrail and the tilt mechanism according to the first aspect of the present invention:
The arrangement of the tilt mechanism is such that it allows switching from right to left orientation. This is accomplished without the need of removing any of the covers of said headrail, should such covers exist.
In addition, the arrangement is such that does not involve the lift cord.
The casing is comprised of two shell elements adapted to be connected to each other; each of said elements is further formed with at least a portion of the hook-receiving channels.
The shell elements may be identical and adapted to be snapped onto one another. Pins, screws or the like may be further implemented for firmer connection of said elements to one another.
Each of the channels of said casing further comprises a leader hole adapted for receiving a tip protrusion of said tilter hook, providing axial support about which the tilter hook is rotatable.
The hook is in the form of a cylindrical bar having a first end and a second end. The first end is adapted for coupling with a torque applying rod or motor, and/or manual gripping, said second end comprising a worm gear for engagement and rotation of the cog-wheel.
The tilter hook also comprises a part of a snapping mechanism adapted to prevent said hook from displacing from said hook-receiving channels, while still allowing it to rotate about its axis.
The tilter hook may further comprise a tip protrusion adapted to fit into the leader hole in either one of the shell elements, adapted to provide further axial support for said hook.
The cog-wheel is adapted to engage with a tilt bar adapted to transfer rotation of said cog-wheel to the blinds. One or more of the teeth of said cog-wheel may be intentionally chipped on one side in order to disengage from the worm gear of said tilter hook, thus preventing over rotation of the cog-wheel in one direction, and consequently over rotation of the blinds.
The tilt mechanism may comprise protrusions adapted for secure snap fitting of the tilt mechanism into the appropriate cut-out of the headrail. Insertion of said mechanism to said headrail may be achieved either by snapping the mechanism straight into the cut-out or sliding it through one of the headrail's open ends into appropriate cut-out.

According to a second aspect of the present invention there is provided a cord lock mechanism for blinds adapted to be secured within a cut-out in a headrail, said mechanism comprising a housing shaped with a slope, and accommodating a fixed stopper member, and a rotatable cog-wheel to be rolled on said slope, said housing being designed for a lift cord to extend therethrough; in addition, two perpendicular shoulders are connected to the housing of said cord lock mechanism, allowing it to be attached to either corner of the headrail's respective cut-out in a removable manner, thus being able to gain a left or a right orientation respectively.

Any of the following design variations may be applied to the headrail and cord-lock mechanism according to the second aspect of the present invention:
The cord-lock mechanism according to the second aspect of the present invention may be used in various blinds including: Roman blinds, Venetian blinds, pleated shades and the like.
The arrangement of the cord-lock mechanism is such that allows switching from a right to a left orientation without the need of removing any of the covers of said headrail, should such covers exist.
In addition, switching from a right to a left orientation, does not involve removal of the lift cord from the cord-lock mechanism and its re-threading after the switching.
The housing is formed such as to accommodate the cog-wheel without it being able to fall or slip out of said housing. This may be achieved either by alignment bars fixed to the housing or simply by the form of the casing itself.
One or more cog-wheels may be used. In case two or more cog-wheels are used, said cog-wheels may be mounted on a mutual shaft.
The cord lock mechanism attaches to the headrail using a snapping mechanism, slide lock or the like.

According to a third aspect of the present invention there is also provided a positioning cover, adapted to close the cut-out side opposite to that in which the cord lock mechanism is positioned, for better positioning of the cord lock mechanism within the cut-out prevention of its sinking into said cut-out, and also for esthetical purposes.

According to a forth aspect of the present invention there is provided a headrail for Venetian type blinds having a main cavity adapted, among other things, for accommodating a lift cord and a tilt bar therein, said headrail comprising a first and second cut-outs, the first cut-out being in the form of two rectangular counter positioned punctures, adapted to receive a tilt mechanism according to the first aspect of the present invention, and the second cut-out being in the form of a rectangular aperture adapted to receive a cord-lock mechanism according to the second aspect of the present invention.

### BRIEF DESCRIPTION OF THE DRAWINGS

In order to understand the invention and to see how it may be carried out in practice, several aspects of the invention will now be described, by way of non-limiting examples only, with reference to the accompanying drawings, in which:

FIG. 1 is an isometric view of a Venetian blind fitted with a tilt mechanism according to the first aspect of the present invention, a cord lock mechanism according to the second aspect of the present invention, a positioning cover according to the third aspect of the present invention, and a headrail according to the forth aspect of the present invention;

FIG. 2 an isometric view of an end portion of the headrail, fitted with the tilt mechanism of FIG. 1;

FIG. 3 is an isometric view of the tilt mechanism according to one aspect of the present invention;

FIG. 4 is an isometric view of a shell element of the tilt mechanism of FIG. 3;

FIG. 5 is an isometric view of a tilter hook of the tilt mechanism of FIG. 3;

FIG. 6 is an isometric view of the tilt mechanism of FIG. 3 with one of the shell elements removed;

FIG. 7 is an isometric view of the cord-lock mechanism according to another aspect of the present invention, fitted within the headrail seen in FIG. 1;

FIG. 8 is an isometric view of the cord-lock mechanism of FIG. 7;

FIG. 9 is a longitudinal side section view of the cord-lock mechanism of FIG. 8;

FIG. 10 is a cross sectional front view of the cord-lock mechanism of FIG. 8;

FIGS. 11A and 11B are isometric views of the cord-lock mechanism of FIG. 8 with a single alignment bar, and with a lift cord passing over and under the alignment bar respectively; and

FIG. 12 is an isometric view of a positioning cover of FIG. 1 used in conjunction with the cord-lock mechanism of FIG. 8;

### DETAILED DESCRIPTION OF EXEMPLARY EMBODIMENTS

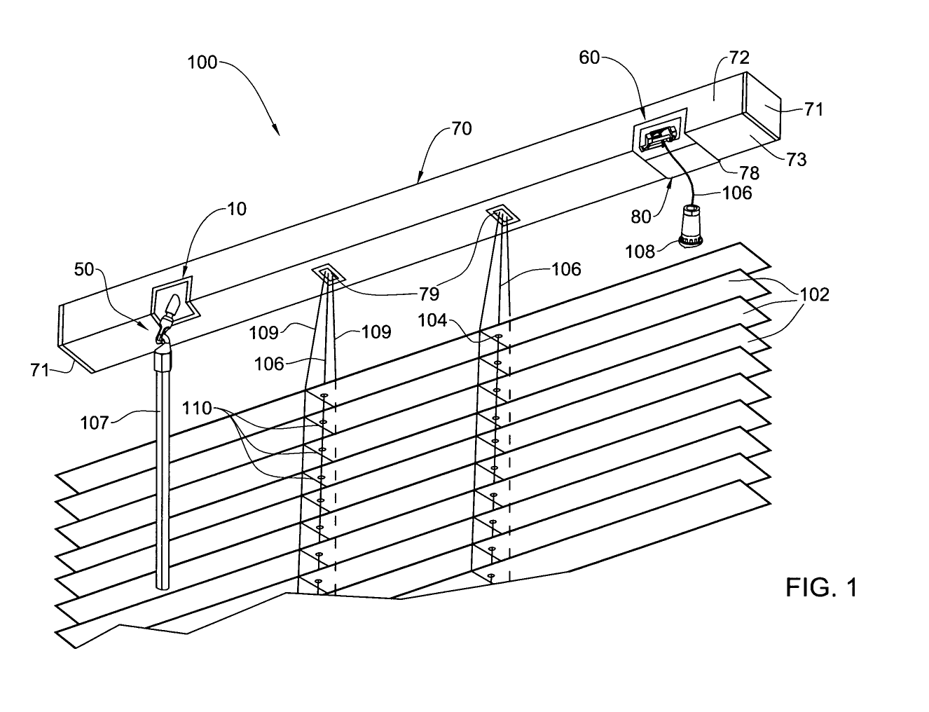

FIG. 1 shows a Venetian type blind assembly, generally designated 100, comprising a headrail 70, a tilt mechanism, generally designated 10, a cord lock mechanism, generally designated 60, and a cover 80. Blinds 102 are held by a lift cord 106 passing through apertures 104 in the blinds. The lift cord 106 is first threaded through cut-outs 79 in the cavity of the headrail 70 and then through the cord lock mechanism 60. The end of the cord is equipped with a small knob 108 for convenient pulling thereon. Two sets of tilter cords 109 are positioned on left side the and right side of the blinds 102, each set comprising a front cord 109F and a rear cord 109R, and being connected to one another using threads 110. A tilter rod 107 is articulated to a tilter hook 30 of the tilter mechanism 10, adapted for rotation thereof. The function of the sets of tilt cords 109 and the tilter rod 107 and hook 30 are to allow tilting the blinds 102 as known per se.

The cord lock mechanism 60 is of right orientation and the tilter hook 30 is fitted in the tilt mechanism 10 such that it acquires a left orientation. The tilter hook 30 may optionally be inserted into the opposite channel 22 as can be seen by the tilter hook marked in phantom lines. The cover 80 is inserted into the cut-out 78 such that it closes the rest of the cut-out 78 on the opposite side of the cord lock mechanism 60.

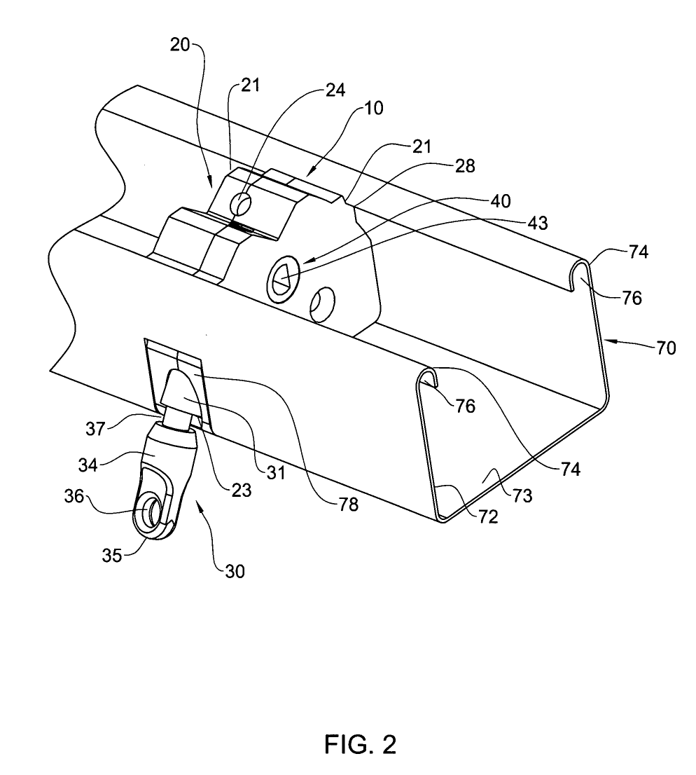

FIG. 2 shows the tilt mechanism 10 attached to the headrail 70. The headrail is formed with a base 73, side walls 72, curved edges 74 forming a recess 76, and a cut-out formed of two apertures 78 on opposite sides of the frame, only one of which is seen in FIG. 1. The tilt mechanism 10 is inserted into the cut-out 78 of the headrail 70 and is fixed therein using positioning protrusions 28.

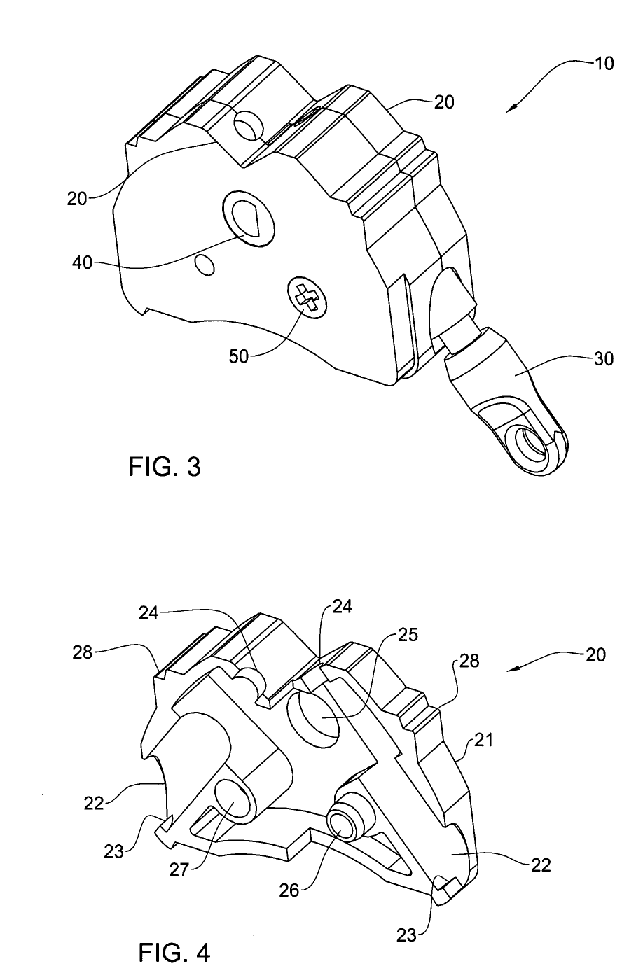

FIG. 3 shows the reversible tilt mechanism 10 comprising two identical shell elements 20, a tilter hook 30, a cog-wheel 40 (only its axis visible) housed between the shell elements 20 and a coupling screw 50. A tilter hook 30 is articulated at one of two positions.

In FIG. 4, the Shell element 20 of the tilt mechanism 10 of FIG. 1 is shown formed with, two tilter hook-receiving channels 22 of semi-circular cross section, each formed with a snapping protrusion 23, two partial hook centering holes 24, a cog-wheel hole 25, a hollow snapping pin 26, a snapping aperture 27 and two positioning protrusions 28.

The shell elements 20 are designed such that two identical elements 20 are adapted to be connected to each other by snapping the hollow snapping pin 26 of one element 20 into the snapping hole 27 of the other element and vice versa. The hollow snapping pin 26 allows the insertion of a screw 50 (FIG. 3) through both shell elements 20 for further fixation of the elements 20 to one another.

The shell elements 20 are designed such that, once attached to each other, the two semi circular tilter hook-receiving channels 22 combine to create two circular cross section channels adapted to receive the tilter hook 30 (not shown). The two partial centering holes 24 combine to create two centering holes adapted to receive a protruding tip 33 of the tilter hook 30. The protrusions 23 at the end of each channel are adapted to snap into a recess 37 of the tilter hook 30 for retention thereof. Furthermore, once assembled, the shell elements 20 are adapted to accommodate a cog-wheel 40 in the cog-wheel hole 25, allowing said cog-wheel 40 to be rotated by a corresponding geared end of the tilter hook 30. The positioning protrusions 28 allow securing of the tilt mechanism 10 within the headrail 70 (not shown).

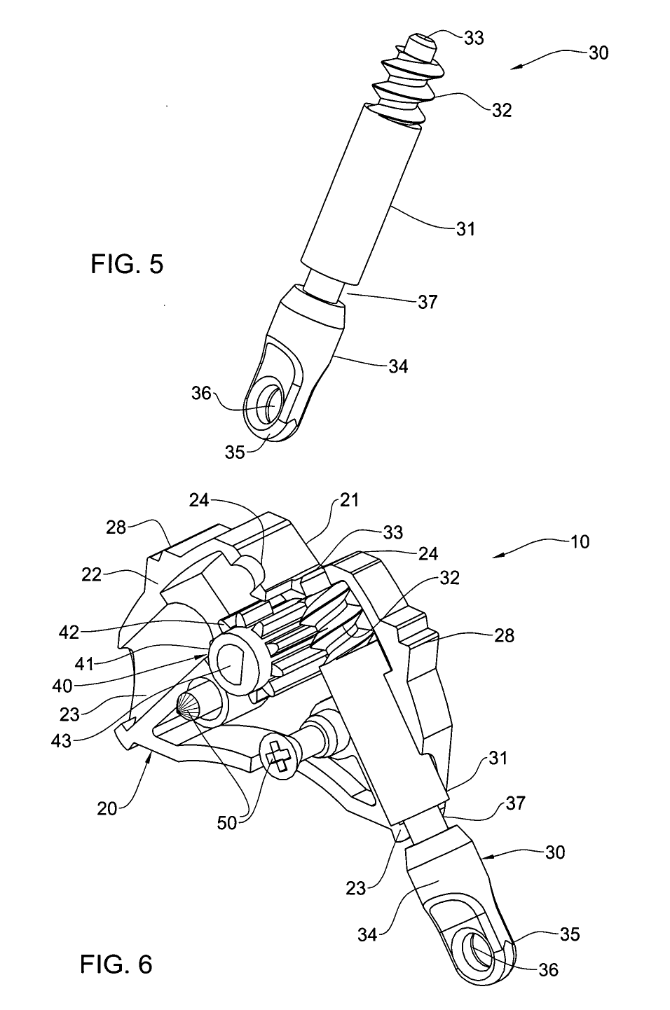

FIG. 5 shows an isometric view of the tilter hook 30 comprising a first portion 31 and a second portion 34. The first portion 31 is adapted to be inserted into either of the channels 22 of the shell elements 20 shown in FIG. 6. The end of the first portion 31 has a worm gear 32 adapted to engage with the cog-wheel 40 (shown FIG. 4) and rotate it. A tip protrusion 33 is adapted to fit into the leader hole 24 of the shell element 20 (shown FIGS. 4 and 6). The snapping protrusions 23 of the shell elements 20 are snapped into recess 37 of the tilter hook 30. The second portion 34 of the hook 30 comprises a flat end 35 with a hole 36 therein, adapted to connect to various rotating means, usually in the form of a long rod, such as tilter-rod 107 in FIG. 1.

In FIG. 6 an assembled tilt mechanism 10 is shown with one of the Shell elements 20 removed. The cog-wheel 40 is inserted into the cog-wheel hole 25 and the tilter hook 30 is inserted into one of the channels 22 of the tilt mechanism 10 such that the tip protrusion 33 of the tilter hook 30 is supported in a rotatable manner within a leader hole 24 and the worm gear 32 of the tilter hook 30 engages the cog-wheel teeth 42. The snapping protrusion 23 is snapped into the recess 37 of the tilter hook 30, fixing it into place, i.e. prevents it from spontaneous disengagement.

In operation, when the tilter hook 30 is rotated, the worm gear 32 rotates the cog-wheel 40 causing the tilter bar within the headrail (not shown) connected to the lead hole 43 of the cog-wheel 40, to rotate. This rotation, depending on its direction, subsequently raises the front tilt cord 109F and lowers the rear tilt cord 109R of visa versa, causing the blinds 102 to tilt in the desired direction.

The tilter hook 30 may be inserted into either one of the channels 22 of the tilt mechanism 10 to allow a left or a right orientation. In order to move from one orientation to the other, the second portion 34 of the tilter hook 30 is moved in an upward direction, to allow disengagement of the tilter recess 37 from the snapping protrusion 23 of the shell element 20. The tilter hook 30 may then be pulled out of one channel 22 and displaced into the opposite channel 22. It is important to note here, that switching from a right to a left orientation and visa versa, does not require removal of the headrail covers 71 (shown FIG. 1).

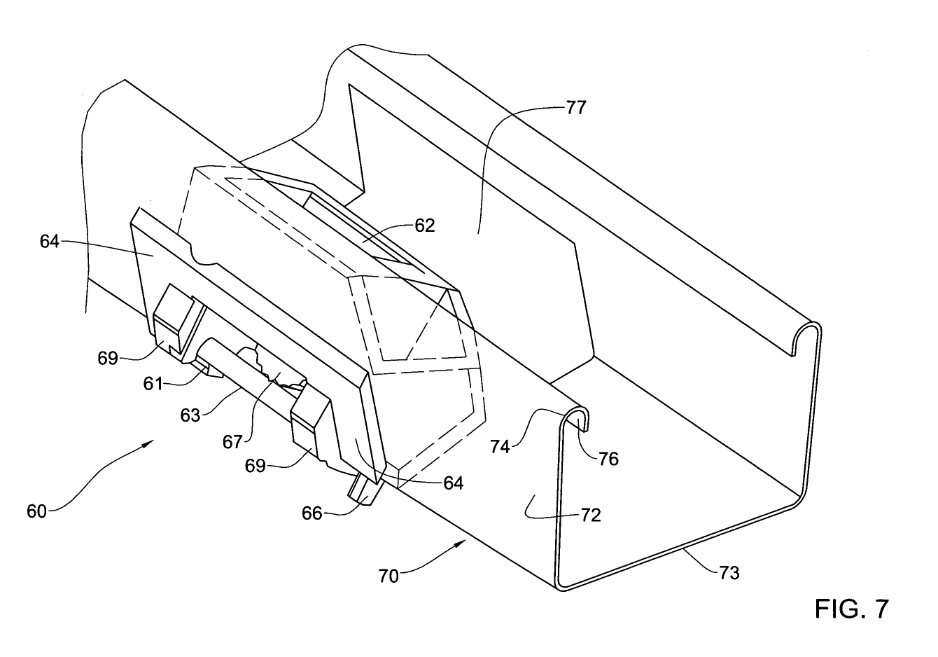

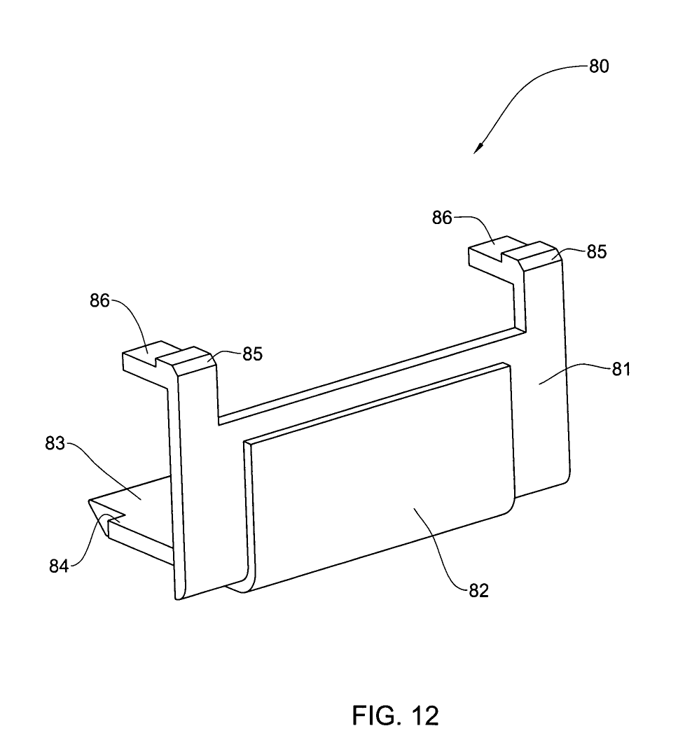

FIG. 7 shows the cord lock mechanism 60 within the headrail 70. The shoulders 64 bear against the side walls 72 and base wall 73 of the headrail 70. The other side of the cut-out 77 is shown open although in operation it is closed by a cover 80 (shown FIG. 12).

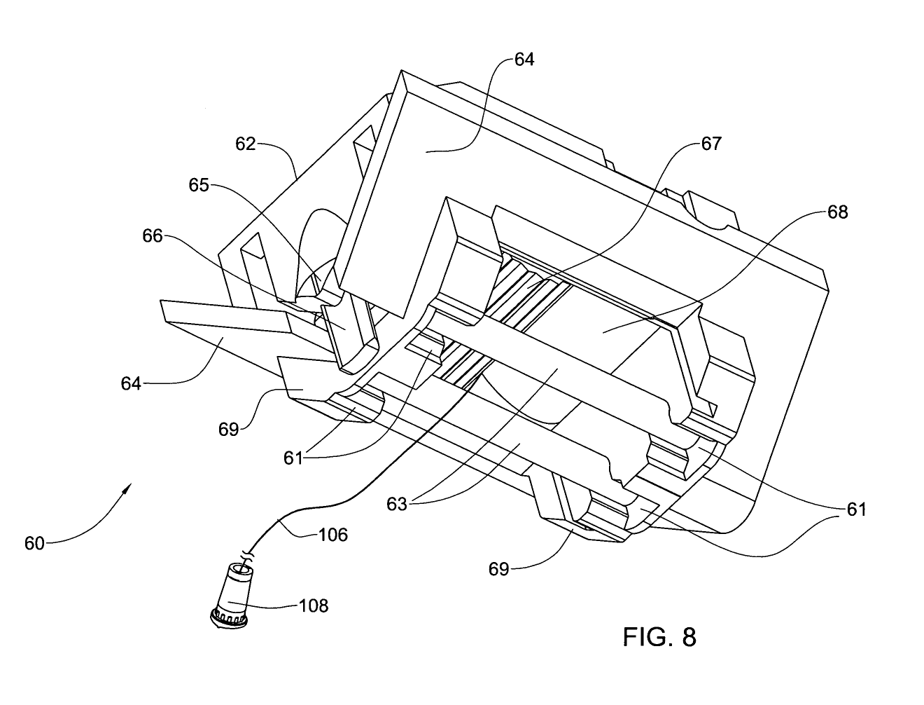

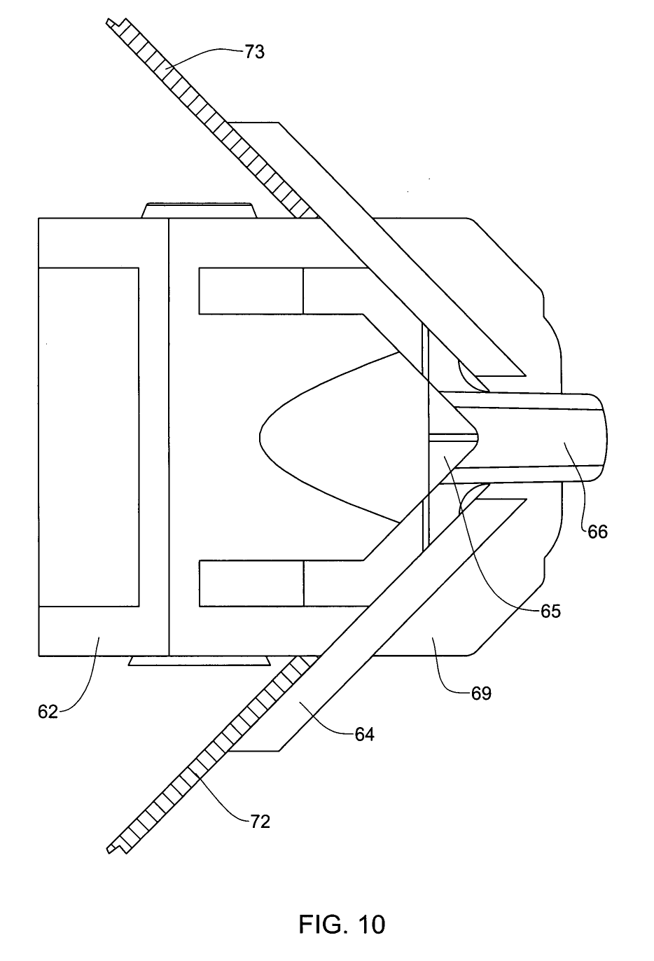

Referring to FIGS. 8 to 10, a cord-lock mechanism 60 is shown comprising a housing 62 formed with two rims 69, each having two indentations 61 adapted for receiving alignment bars 63 by snap connection, two diagonal shoulders 64 having an angle of 90° therebetween and a jagged slope 90. The housing 62 further comprises, a snapping arrangement consisting of a wedge 65 and a snap release arm 66. Accommodated within the housing are a stopper member 68 fixed between both sided of the housing 62, and a cog-wheel 67, which rests within the housing 62 in a freely rotatable manner, due to which, a gap between the cog-wheel 67 and the stopper member 68 may be created, allowing threading of a lift cord (shown FIG. 1) therethrough.

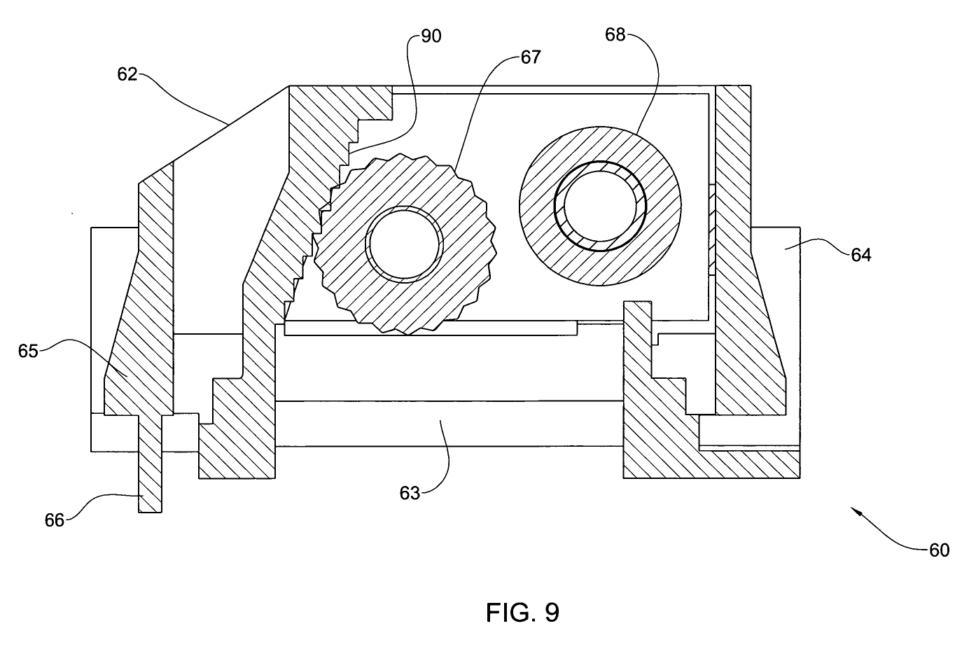

In operation, the lift cord 106 is threaded between the cog-wheel 67 and the stopper member 68, and between the two alignment bars 63. During the raising of the blinds 102, the lift cord is pulled until the blinds 102 are at a desired position, and released. When the lift cord 106 is released, the weight of the blinds 102 pulls on the cord, forcing the cog-wheel 67 to roll along the slope 90 (shown FIGS. 8 and 9) in an upward direction until the cord is snapped tight between the cog-wheel 67 and the stopper member 68, preventing the blinds 102 from further downward displacement. During lowering of the blinds, when the lift cord 106 is pulled a bit downwards and slightly to a direction opposite of the cog-wheel 67, the lift cord 106 disengages the cog-wheel 67 reducing pressure thereon, letting it fall to the bottom of the housing 69 whereby the lift cord is free to slip against the stopper member 68. Once the lift cord 106 is pulled towards the cog-wheel 67 and released, the weight of the blinds forces it to roll against the slope 90 and the cord is snapped as previously described.

In order to switch from a right to a left orientation, the snapping release arm 66 is pressed and the entire cord-lock mechanism 60 may be removed from the cut-out 78 in which it was positioned. Upon removal of the cord-lock mechanism 60 from the cut-out 78, it may be replaced in the opposite cut-out 78 of the headrail 70, thus gaining an opposite orientation, wherein the above process neither involves removal of the lift cord 106 and its re-threading into the housing 62, nor does it require removal of either of the headrail covers 71.

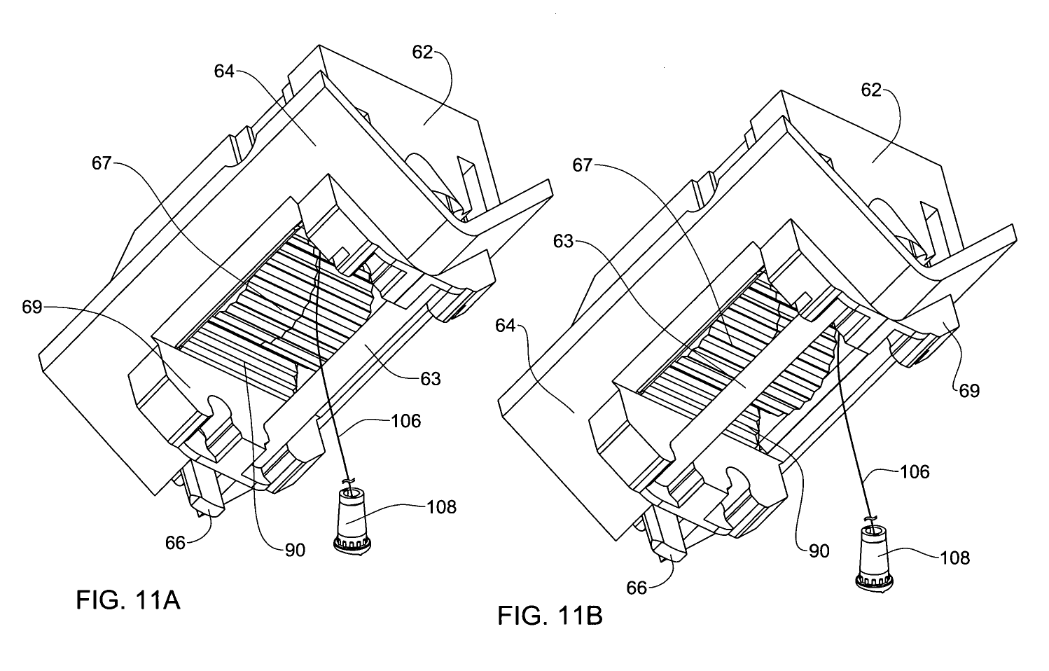

In accordance with FIGS. 11A and 11B, it is important to emphasize the function of the alignment bars 63. When switched from one orientation to the other, the lift cord 106 must remain aligned with the cog-wheel 67 in order to allow proper raising and lowering of the blinds. In standard blinds this alignment is achieved by a single alignment bar, wherein the lift cord passes over the alignment bar (FIG. 11A). However, in this situation, switching the orientation of the cord-lock mechanism from a left orientation to a right orientation will cause the lift cord to pass under the alignment bar, essentially hanging loose (FIG. 11B), thus being susceptible to malfunction during operation of the blinds due to improper alignment with the cog-wheel. For this purpose, among others, two alignment bars 63 are used in the present embodiment, allowing the lift cord 106 to pass over either one or the other alignment bar 63, remaining aligned with the cog-wheel 67 regardless the orientation of the cord-lock mechanism 60.

FIG. 12 shows a cover 80, adapted for closing a part of the cut-out 78 not being used by the cord lock mechanism 60. The cover 80 is formed with a vertical plate 81 connected to a bent plate having a vertical portion 82 and a horizontal portion 83. The vertical plate has two raised protrusions with chamfered tips 85 and connected thereto, horizontal extensions 86.

In operation, the cover 80 is inserted into the headrail (shown FIG. 1) such that the chamfered tips 85 are inserted into the recess 76 of the headrail 70. In this position, the horizontal portion 83 of the bent plate covers the bottom side of the headrail 70 whereas the vertical portion 82 of the bent plate covers the side of the headrail 70. The vertical plate 81 is flush against the inner side of the headrail 70, further fixing it into position. The horizontal portion 83 of the bent plate presses against the cord lock mechanism 60, preventing it from sliding into the cavity of the headrail 70.

Those skilled in the art to which this invention pertains will readily appreciate that numerous changes, variations and modifications can be made without departing from the scope of the invention mutatis mutandis.

1. A tilt mechanism for blinds adapted to be secured within a cut-out in a headrail, said tilt mechanism comprising a casing, adapted to accommodate a cog-wheel rotatable about a first axis, said casing comprising two counter-positioned tilter hook-receiving channels, each leading to said cog-wheel sized and shaped for receiving at least a portion of a rotatable tilter hook adapted to engage and rotate said cog-wheel, said tilter hook designed for insertion into either one of said channels, thus being able to gain a left or right orientation.

2. A mechanism according to claim 1, wherein switching from a right to a left orientation is achieved without the need of removal of headrail covers, should such covers exist.

3. A mechanism according to claim 1, wherein the casing is comprised of two or more shell elements, each being formed with at least a part of the tilter hook-receiving channels.

4. A mechanism according to claim 3, wherein two shell elements are identical.

5. A mechanism according to claim 3, wherein the shell elements are adapted to be snapped to each other and/or formed such that pins or screws may be used thereon for firmer connection of said shell elements.

6. A mechanism according to claim 1, wherein at least one of the channels has a leader hole adapted to receive a tip protrusion of the tilter hook.

7. A mechanism according to claim 1, wherein the tilter hook is in the form of a cylindrical bar having a first and a second end, said first end being adapted for connection with a torque applying rod or motor, and/or manual gripping, said second end having a worm gear allowing rotation of the cog-wheel by rotation of said tilter hook once the two are engaged.

8. A mechanism according to claim 1, wherein the tilter hook also comprises a part of a snapping mechanism adapted to prevent said hook from displacing from said hook-receiving channels, while still allowing it to rotate about its axis.

9. A mechanism according to claim 1, wherein the cog-wheel is adapted to engage with a tilt bar adapted to transfer rotation of said cog-wheel to the blinds, one or more of the teeth of said cog-wheel is intentionally chipped on one side in order to disengage from the worm gear of said tilter hook, thus preventing over rotation of the cog-wheel in one direction, and consequently over rotation of the blinds.

10. A mechanism according to claim 1, wherein said mechanism comprises protrusions adapted for secure snap fitting of said tilt mechanism into the appropriate cut-out of a headrail, and insertion of said mechanism to said headrail is achieved either by snapping the mechanism straight into the cut-out or sliding it through one of the headrail's open ends into the respective cut-out.

11. A tilt mechanism according to claim 1, wherein the blind is a Venetian blind.

12. A cord lock mechanism for blinds, adapted to be secured within a cut-out in a headrail, said mechanism comprising a housing shaped with a slope, and accommodating therein a fixed stopper member, and a rotatable cog-wheel to be rolled on said slope, said housing being designed for a lift cord to extend therethrough; in addition, two perpendicular shoulders are connected to the housing of said cord lock mechanism, allowing it to be attached to either corner of the headrail's respective cut-out, optionally in a removable manner, thus being able to gain a left or a right orientation respectively.

13. A mechanism according to claim 12, wherein said blinds are selected from Roman blinds, Venetian blinds and Pleated shade.

14. A mechanism according to claim 12, wherein switching from right to left orientation is achieved without the need of removal of headrail covers, should such covers exist.

15. A mechanism according to claim 12, wherein switching from right to left orientation does not involve removal of the lift cord from the housing.

16. A mechanism according to claim 12, wherein the housing is formed such as to accommodate and retain the cog-wheel in a rotatable manner.

17. A mechanism according to claim 12, wherein the cord-lock mechanism is attached to the headrail by snap engagement.

18. A cord-lock mechanism according to claim 12, wherein the blind is a Venetian blind.

19. A chord lock mechanism according to claim 12, further comprising at least two alignment bars adapted to align said lift cord with said cog-wheel in both a right and a left orientation.

20. A Venetian blind fitted with one or both of a tilt mechanism as claimed in claim 1.
